(19) United States
(12) Patent Application Publication
(10) Pub. No.: US 2015/0063637 A1
(43) Pub. Date: Mar. 5, 2015

(54) IMAGE RECOGNITION METHOD AND ROBOT

(71) Applicant: TOYOTA JIDOSHA KABUSHIKI KAISHA, Toyota-shi (JP)

(72) Inventor: Ayako AMMA, Toyota-shi (JP)

(73) Assignee: TOYOTA JIDOSHA KABUSHIKI KAISHA, Toyota-shi (JP)

(21) Appl. No.: 14/467,458

(22) Filed: Aug. 25, 2014

(30) Foreign Application Priority Data
Aug. 27, 2013 (JP) 2013-175497

(51) Int. Cl. G06K 9/00

(52) U.S. Cl. CPC G06K 9/00664; G06K 9/00791; G06T 2207/10016; G06T 2207/30241; G06T 2207/20076; G06T 2207/30244; Y10S 901/47
USPC 382/103; 901/47

(57) ABSTRACT

An image recognition method according to one exemplary aspect of the present invention including the steps of: acquiring a shooting image generated by capturing an image of an object using an image generating device; acquiring subject distance information indicating a distance from the object to the image generating device at a target pixel in the shooting image; extracting an image pattern corresponding to the acquired subject distance information from a plurality of image patterns which are created for detecting one detection object in advance and are associated with the different distance information, respectively, and performing a pattern matching using the extracted image pattern against the shooting image.

### INCORPORATION BY REFERENCE

This application is based upon and claims the benefit of priority from Japanese patent application No. 2013-175497, filed on Aug. 27, 2013, the disclosure of which is incorporated herein in its entirety by reference.

### BACKGROUND OF THE INVENTION

1. Field of the Invention

The present invention relates to an image recognition method and a robot.

2. Description of Related Art

In the field of image recognition, a template matching (a pattern matching) is known. In the template matching, images of particular patterns (template images) are previously stored. A characteristic amount of an image acquired by a camera or the like is compared with that of the template image, and therefore a specific pattern is detected from the acquired image (e.g., Japanese Unexamined Patent Application Publication No. 2013-101423).

### SUMMARY OF THE INVENTION

However, in the template matching, it is necessary to check all areas of the acquired image against all template images of all sizes. Therefore, there is a problem that it takes much time to do a match processing since a calculation amount is increased.

On the other hand, it is also conceivable to perform the template matching using a reduced feature amount of an image to reduce the calculation amount. However, because the feature amount is reduced, there is a possibility that an accuracy of a matching process is reduced, and a false recognition occurs.

The present invention has been accomplished to solve the above problems and an object of the present invention is thus to provide an image recognition method and a robot which can shorten the processing time of the matching process while maintaining the accuracy of the matching process.

An image recognition method according to one exemplary aspect of the present invention including the steps of: acquiring a shooting image generated by capturing an image of an object using an image generating device; acquiring subject distance information indicating a distance from the object to the image generating device at a target pixel in the shooting image; extracting an image pattern corresponding to the acquired subject distance information from a plurality of image patterns which are created for detecting one detection object in advance and are associated with a plurality of different pieces of distance information, respectively, and performing a pattern matching using the extracted image pattern against the shooting image.

Further, the shooting image includes a 3D image in which each pixel has the subject distance information, and the image pattern includes the 3D image of the detection object. It may further include the steps of: acquiring the subject distance information at the target pixel from the 3D image as the shooting image; extracting the 3D image of the detection object corresponding to the acquired subject distance information; and performing pattern patching using the extracted 3D image of the detection object against the 3D image as the shooting image.

The shooting image further includes a color image in which each pixel has color information and the image pattern further includes the color image of the detection object. It may further include the steps of: performing the pattern matching using the 3D image and the color image of the detection object against the 3D image and the color image as the shooting image.

The image pattern may include the template image showing the detection object, a size of the template image may differ depending on the distance information associated with the template image, and a size of a comparison area which may be compared with the template image in the shooting image varies according to the size of the template image used in the pattern matching.

The image recognition method may further include the steps of: acquiring the subject distance information which the target pixel has and the subject distance information which peripheral pixels of the target pixel have; calculating an average value of the acquired plurality of pieces of the subject distance information; and extracting the image pattern corresponding to the calculated average value from the plurality of image patterns created in advance.

The image recognition method may further include the steps of: extracting the image pattern associated with the distance information regarding which the difference between itself and the acquired subject distance information from the plurality of image patterns created in advance is the smallest.

A robot according to one exemplary aspect of the present invention including an image generating device; a memory which stores a plurality of image patterns associated with the plurality of different pieces of distance information, respectively; and an image recognition device performing an image recognition method according to claim 1.

It is possible to provide an image recognition method and a robot which can shorten the processing time of the matching process while maintaining the accuracy of the matching process.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a view for explaining a process of a template matching according to an exemplary embodiment;

FIG. 2 is a block diagram showing an image processing system according to the exemplary embodiment;

FIG. 3 is an example of a camera image according to the exemplary embodiment;

FIG. 4 is an example of a 3D image according to the exemplary embodiment;

FIG. 5 is a view for explaining a method of creating a template image according to the exemplary embodiment;

FIG. 6 is a view for explaining a data structure of the template image according to the exemplary embodiment;

FIG. 7 is a flow chart showing an operation of the image processing system according to the exemplary embodiment;

FIG. 8 is a view for explaining a method of extracting a template image group according to the exemplary embodiment;

FIG. 9 is a view for explaining the effect of preventing erroneous detection according to the exemplary embodiment;

FIG. 10 is a view for explaining a method of calculating the subject distance of the target pixel according to a modification embodiment; and

FIG. 11 is a view for explaining a method of extracting the template image group according to the modification embodiment.

### DESCRIPTION OF THE EXEMPLARY EMBODIMENTS

### Exemplary Embodiment

Hereinafter, with reference to the drawings, exemplary embodiments of the present invention will be described. An image recognition device according to the present exemplary embodiment performs a pattern matching to find a predetermined image pattern, which is set in advance, from a camera image captured an image of an object using the camera. In the following description, a case using a so-called template matching of the pattern matching will be described. The template matching is a method that uses a template image of the object to be detected (hereinafter, the detection object) as an image pattern, and checks the camera image against the template image to estimate a position and a posture of the detection object in the camera image.

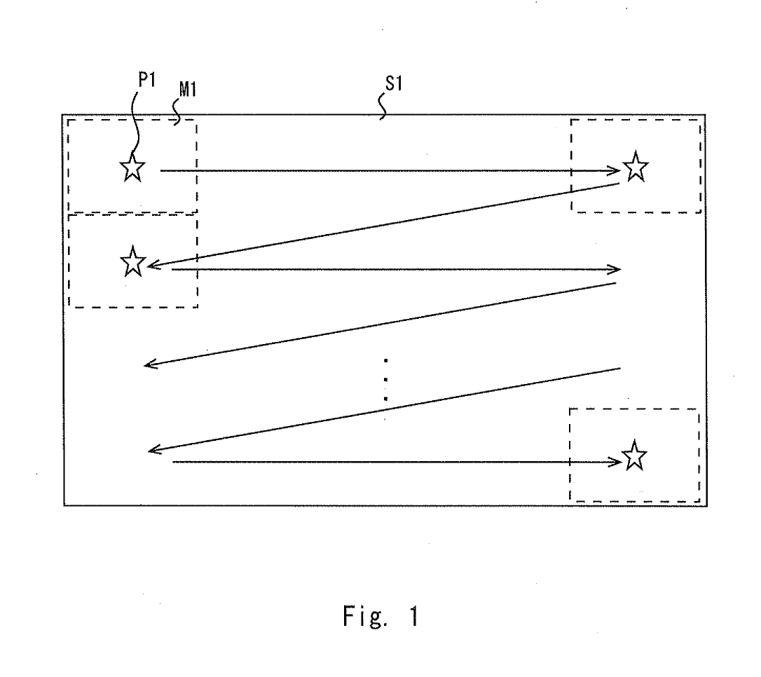

Here, an operation of the template matching will be briefly described with reference to FIG. 1. First, a target pixel P1 is determined in a camera image S1. Note that the camera image S1 is a shooting image generated by the camera. Then, a matching area M1 (an area surrounded by dashed lines) including the target pixel P1 is set. The matching area M1 which is a part of the area of the camera image is also a comparison area to be compared with the template image. That is, the target pixel P1 is a pixel for determining the position of the matching area M1 in the camera image. In the example shown in FIG. 1, the matching area M1 is set in such a way that the target pixel P1 is the center of the matching area M1. The size (the number of pixels) of the matching area M1 is equal to the size of the template image. The matching area M1 is compared with the template image each time the target pixel P1 is moved a predetermined distance and in a predetermined direction, and a score (degree of matching of the image) is calculated. Then, by moving the target pixel P1 over the entire camera image S1, the template matching is performed against the entire camera image S1 using the matching area M1.

Note that it is possible to use existing methods in the comparison between the matching area M1 and the template image and in the calculation of the score, but they are not particularly limited thereto. For example, it is possible to use the so-called area (correlation) based matching such as SAD (Sum of Absolute Differences), SSD (Sum of Squared Differences), NCC (Normalized Cross Correlation), or POC (Phase-Only Correlation). Therefore, detailed descriptions of the comparison process and the score calculation process are omitted.

### [Configuration of an Image Processing System]

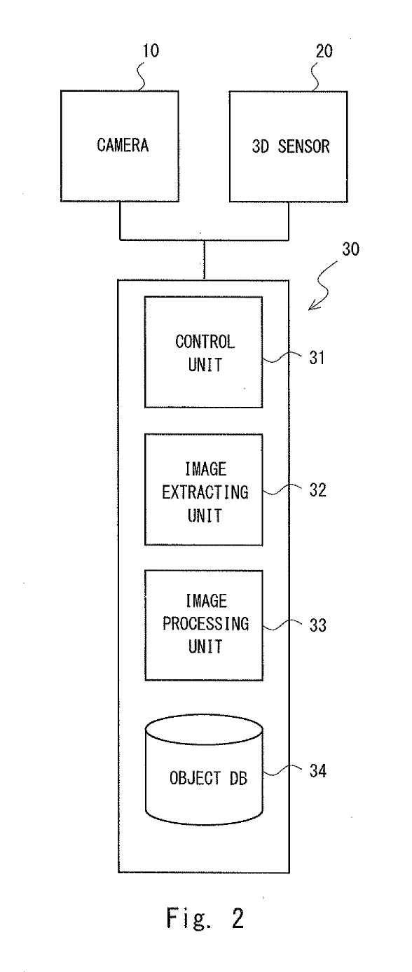

FIG. 2 shows a block diagram of an image processing system according to the exemplary embodiment. The image processing system includes a camera 10, a 3D (three-dimensional) sensor 20 and an image recognition devise 30.

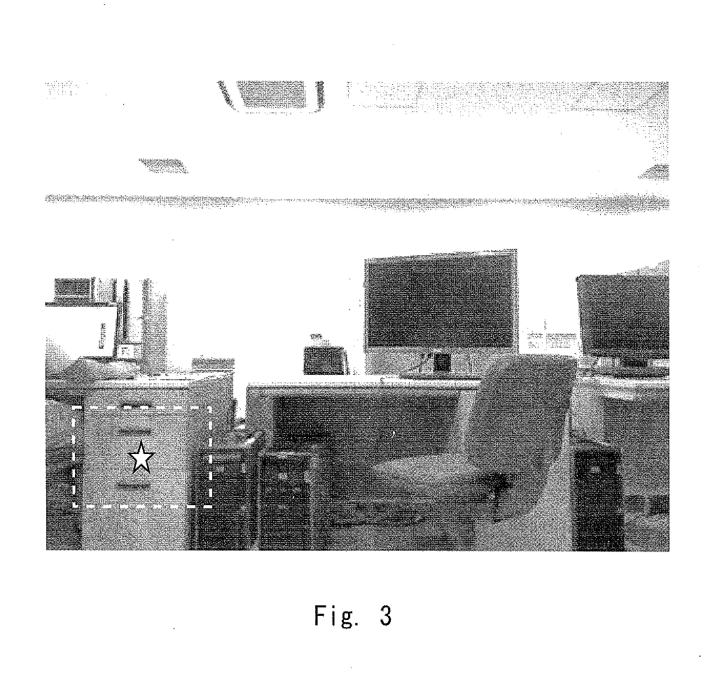

The camera 10 (image generating device) includes a lens group and an image sensor or the like, which are not shown. The camera 10 preforms an imaging process, and generates the camera image as the shooting image. The camera image (color image), for example, is an image as shown in FIG. 3, and each pixel has an RGB value (color information).

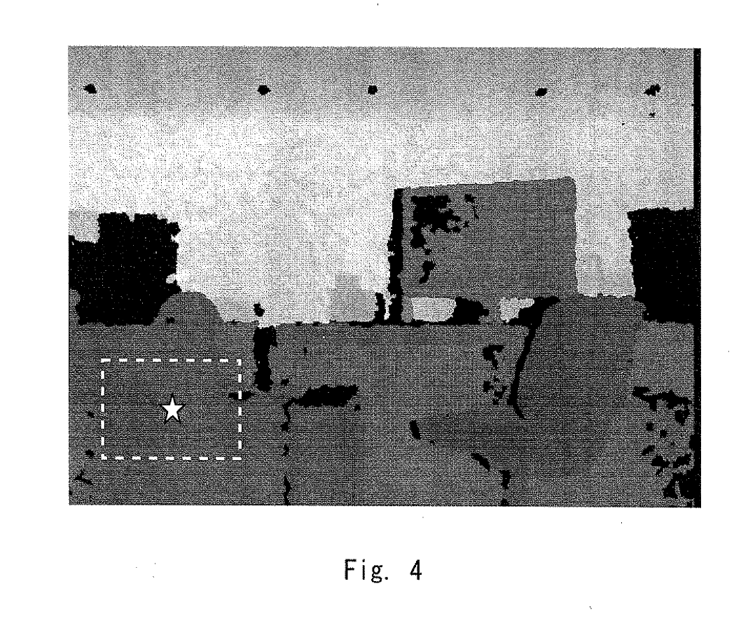

The 3D sensor 20 (an image generating device) performs an imaging process and generates a 3D (three-dimensional) image as the shooting image. Specifically, the 3D sensor 20 acquires information (subject distance information) indicating the distance from the camera 10 (or the 3D sensor 20) to the object in an angle of view corresponding to an angle of view of the camera 10. More specifically, the 3D sensor 20 is disposed in the vicinity of the camera 10, and acquires the distance from the 3D sensor 20 to the object as the subject distance information. Then, the 3D sensor 20 generates the 3D image using the subject distance information. In the 3D image, each pixel has the subject distance information. That is, the 3D image is an image having information regarding the depth of the object. For example, as shown in FIG. 4, the 3D image is a grayscale image, and a color density of the pixel is changed in accordance with the subject distance information. As the 3D sensor, for example, it is possible to use a camera using the TOF (Time Of Flight) method or a stereo camera and the like.

The image recognition devise 30 includes a control unit 31, an image extracting unit 32, an image processing unit 33, and the object DB (Database) 34. The control unit 31 is composed of a semiconductor integrated circuit including a CPU (Central Processing Unit), a ROM (Read Only Memory) which stores various programs, and RAM (Random Access Memory) as a work area or the like. The control unit 31 transmits instructions to each block of the image recognition devise 30 and generally controls the processing of the image recognition devise 30 as a whole.

The image extracting unit 32 acquires the subject distance information of the target pixel in the camera image from the 3D image. Then, the image extracting unit 32 extracts the template image used for the template matching from the plurality of template images (image patterns) which are stored in the object DB 34 in advance, in accordance with the acquired subject distance information. Note that the target pixel may be set in the 3D image instead of in the camera image.

The image processing unit 33 performs the template matching to the camera image and the 3D image using the template image which is extracted by the image extracting unit 32. The image processing unit 33 makes the template image, the score (matching of the image) of which becomes equal to or greater than a predetermined threshold, as a recognition result. That is, the image processing unit 33 determines that the detection object included in the template image, the score of which becomes equal to or greater than a predetermined threshold, exists in the camera image.

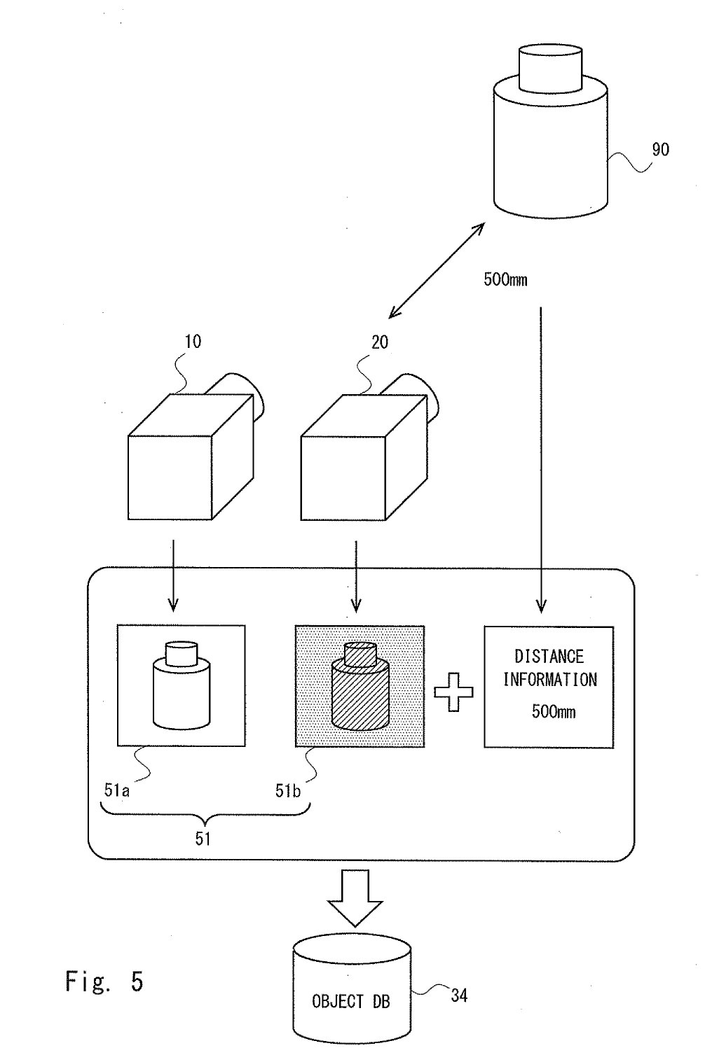

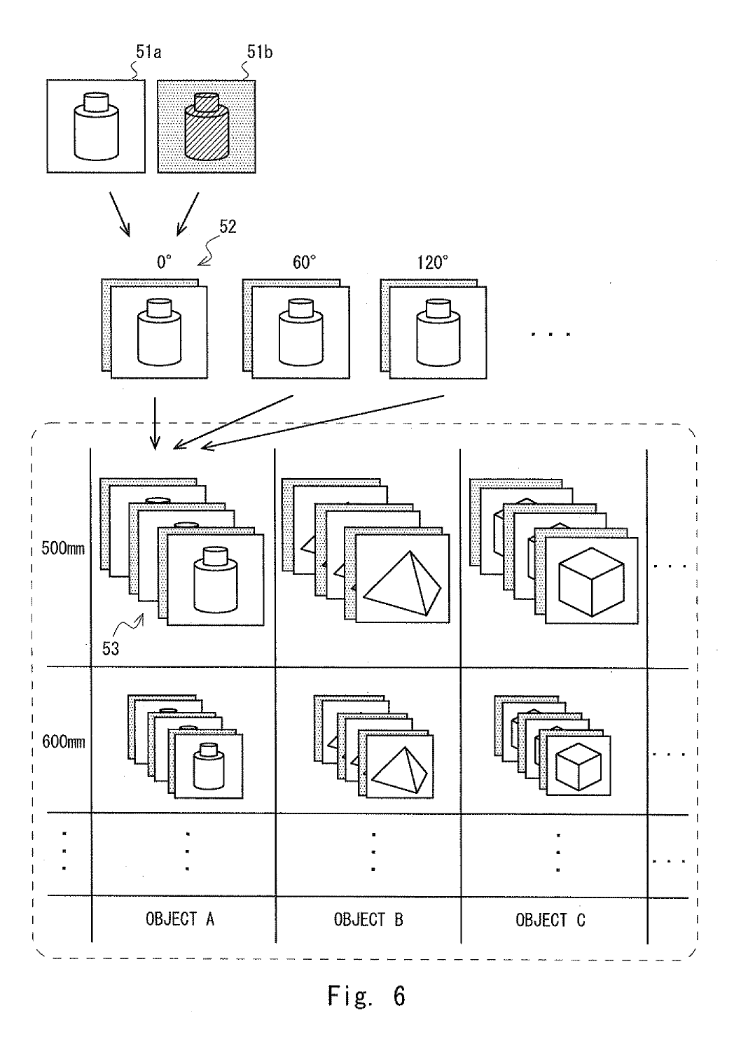

The object DB 34 is a memory such as a HDD (Hard Disk Drive). The object DB 34 previously stores a plurality of template images in association with a plurality of pieces of the object distance information. Specifically, the object DB 34 stores the plurality of template images, which are created in advance so as to detect one detection object, in association with different pieces of distance information, respectively. With reference to FIGS. 5 and 6, data creation in the object DB 34 and data structures will be described in detail

First, referring to FIG. 5, data creation in the object DB34 will be described. Beforehand, a user takes images of a detection object 90 in the plurality of different subject distances using the camera 10 and the 3D sensor 20. Thus, the user acquires a camera image 51a taken by using the camera 10 and a 3D image 51b taken by using the 3D sensor 20. In the following description, the camera image 51a of the detection object and the 3D image 51b of the detection object are sometimes simply referred to as a template image 51. Then, the user stores the subject distance when images are taken in the object DB 34 as distance information in association with the camera image 51a and the 3D image 51b. As shown in the example of FIG. 5, the camera image 51a and the 3D image 51b, which are taken at the subject distance 500 mm, are stored in the object DB 34 as the template image in association with the distance information of 500 mm. The distance information associated with the camera image 51a and the 3D image 51b can be acquired from the 3D image or the user can enter it manually.

Next, with reference to FIG. 6, the data structure of the object DB 34 will be described. The camera image 51a and the 3D image 51b of the detection object exist as the template image of one detection object (e.g. an object A). A combination of both the camera image 51a and the 3D image 51b is referred to as a template image pair 52. One template image pair 52 includes the template image 51 (the camera image 51a and the 3D image 51b) of the detection object viewed from one angle. The object DB 34 stores a plurality of the template image pairs 52 acquired by imaging the detection object from different angles. In other words, the object DB 34 stores the template image pair 52 with respect to each angle. For example, as shown in FIG. 6, when the image is captured around the detection object every 60°, the object DB 34 stores template image pairs 52 taken from each of the angles 0°, 60°, 120°, 180°, 240°, and 300°. In the following description, a plurality of template image pairs 52 acquired by capturing the image of the detection object from different angles are referred to as template image groups 53.

That is, one template image group 53 includes template images of (the number of the template image pair 52)×(the camera image and the 3D image included in each template image pair 52 (=2)). For example, when template image pairs 52 acquired by capturing the image of the detection object from six different angles exist, 6×2=12 template images are included in one template image group 53.

Further, the object DB 34 previously stores the plurality of template image groups 53 associated with different distance information for one detection object. For example, when a plurality of pieces of distance information is composed of three types of distance information, namely, 400 mm, 500 mm, and 600 mm, one template image group is associated with the distance information of 400 mm. Similarly, one template image group is associated with the distance information of 500 mm and one template image group is associated with the distance information of 600 mm.

That is, the object DB 34 includes (the number of types of distance information)×(the number of template images included in one template image group) template images. For example, as in the above example, when the template image pair acquired by capturing the image of the detection object from six different angles exists, twelve template images are included in one template image group. If there are three types of distance information, 3×12=36 template images are stored for one detection object in the object DB 34.

Further, if a plurality of types of detection objects exists, the object DB 34 stores a plurality of different template image groups, which corresponds to the respective detection objects, and the plurality of different template image groups are associated with one distance information. For example, if there are three types of detection objects (an object A, an object B and an object C), three template image groups in total (one template image group corresponding to the object A, one template image group corresponding to the object B and one template image group corresponding to the object C) are associated with one distance information. Explaining with reference to the above example, the object DB 34 stores 3 (the number of types of detection objects)×36 (the number of template images for one detection object)=108 template images. Thus, data with the structure surrounded by a dashed line in FIG. 6 is stored in the object DB 34.

In addition, the size (the number of pixels) of the template image 51 varies according to the distance information associated with it. That is, a plurality of the template image groups 53 of different sizes is associated with different pieces of distance information, respectively. Specifically, the size of the template image in the case where the distance information is short (the subject distance when the template image is generated is close) is larger than that in the case where the distance information is long (the subject distance when the template image is generated is far). The size (the number of pixels) of the detection object in the camera image (or the 3D image) in the case where the subject distance is close is larger than that in the case where the subject distance is far. Thus, by changing the size of the template image according to distance information in advance, the template image of a smaller size is used as the subject distance information becomes farther. Therefore, the number of pixels to be compared can be reduced compared with the case where the matching uses the template images of the same size in all of the subject distances. As a result, it is possible to shorten the time of the matching process.

As to the image pattern, it is not limited to the image itself of the detection object such as the template image, and it is possible to use various feature amounts for identifying the image.

### <Operation of the Image Processing System>

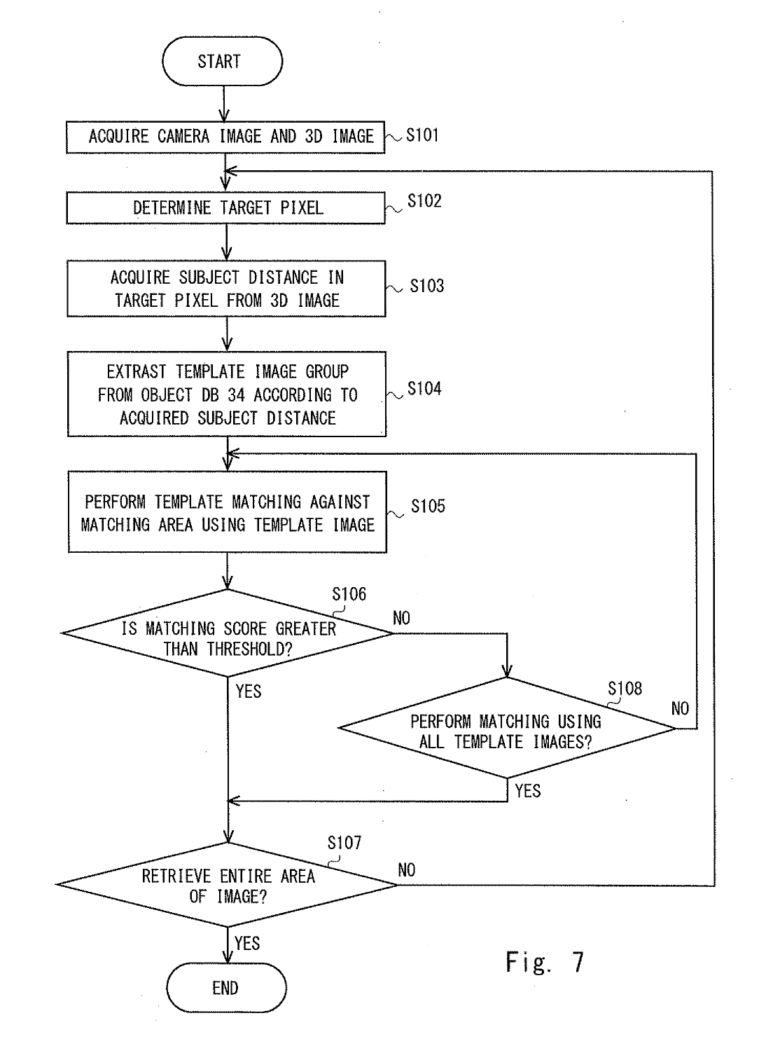

Next, the image recognition method according to the exemplary embodiment will be described with reference to a flow chart shown in FIG. 7. Note that before the operation shown in FIG. 7, it is assumed that the object DB 34 previously stored a plurality of template image groups associated with the distance information (see FIG. 6).

First, the camera 10 and the 3D sensor 20 capture the image of the subject. Thus, the camera 10 generates the camera image (the color image). Further, the 3D sensor 20 generates the 3D image.

The image processing unit 33 acquires the camera image and the 3D image generated by the camera 10 and the 3D sensor 20 (step S101).

Next, the image processing unit 33 determines the position of the target pixel in the camera image and the 3D image (step S102). That is, the image processing unit 33 determines the position of the matching area to be matched with the template image in each of the camera image and the 3D image. The target pixel is a point indicated by a star in FIGS. 3 and 4. For example, the position of the target pixel is specified by using the x-y coordinates in the image.

Further, the target pixel in located at the same point of the same subject in both the camera image and in the 3D image. The camera 10 and the 3D sensor 20 are disposed in close proximity to each other, but not in the same position. Thus, slight deviation occurs between the angle of view of the camera image and the angle of view of the 3D image. That is, the coordinates of the same point of the same object in each image are different. However, the distance between the camera 10 and the 3D sensor 20 can be measured in advance. Therefore, it is possible to place the target pixel at the same point of the same subject in both the camera image and in the 3D image by shifting the coordinates of the target pixel in either one image of two.

After the image processing unit 33 determines the position of the target pixel, the image extracting unit 32 acquires the subject distance information, which the target pixel in the 3D image has, from the 3D image (step S103). Then, the image extracting unit 32 extracts the template image group corresponding to the acquired subject distance information from the object DB 34 (step S104).

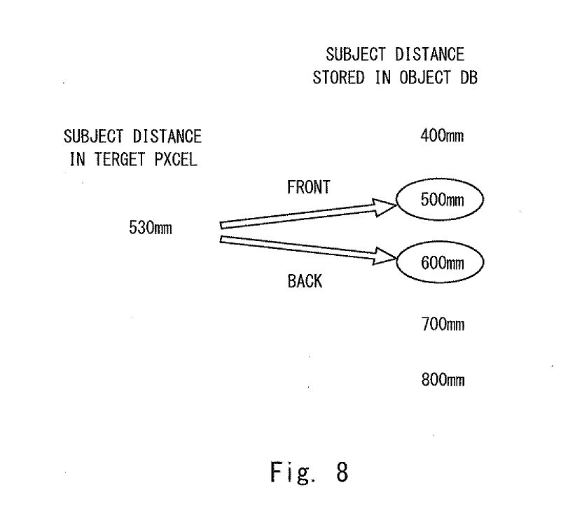

With reference to FIG. 8, the extraction processing by the image extracting unit 32 will be described. In the example shown in FIG. 8, it is shown when the subject distance information in the target pixel is 530 mm. Further, it is assumed that the template image groups associated with the distance information of 400 mm, 500 mm, 600 mm, 700 mm and 800 mm are stored in the object DB 34.

When the image extracting unit 32 acquires 530 mm as the subject distance information of the target pixel in the 3D image, the image extracting unit 32 retrieves the distance information of around 530 mm from among the different types of distance information previously stored in the object DB 34. For example, the image extracting unit 32 retrieves the distance information in the vicinity of the acquired subject distance information in the object DB 34. That is, the image extracting unit 32 detects 500 mm, which is the front side (near side) of 530 mm and is the closest to 530 mm. In addition, the image extracting unit 32 detects 600 mm, which is the back side (far side) of 530 mm and is the closest to 530 mm. Then, the image extracting unit 32 extracts the template image group associated with the distance information of 500 mm and the template image group associated with the distance information of 600 mm from the object DB 34. At this time, the image extracting unit 32 extracts template image groups associated with the distance information 500 mm or 600 mm for each of the plurality of detection objects (the object A, the object B, and the object C).

Then, the image extracting unit 32 output the extracted template image groups to the image processing unit 33. The image processing unit 33 performs the template matching against the target pixel centered area which is determined in step S102 (the matching area, the area surrounded by a dashed line in FIGS. 3 and 4) using the template image included in the extracted template image group (step S105). That is, the image processing unit 33 calculates the score by comparing each of the template images and the matching area. The image processing unit 33 performs the matching process using the camera image 51 a of the detection object (see FIGS. 5 and 6) as the template image against the camera image acquired in step S101. Similarly, the image processing unit 33 performs the matching process using the 3D image 51b of the detection object (see FIGS. 5 and 6) as the template image against the 3D image acquired in step S101.

The size of the matching area in the camera image is the same as the size of the template image to be matched. That is, the size of the matching area corresponds to the size of the template image to be used and varies depending on the size of the template image. Specifically, the size of the matching area in the case where the subject distance information of the target pixel is short is smaller than where in the case that the subject distance information is long. Thus, it is possible to use the size of the template image as the size of the matching area.

It is also conceivable to calculate the optimum size of the matching area on the basis of the subject distance and the size of the detection object. However, it takes a long time to do a matching process because it is necessary to calculate the optimum size of the matching area each time the matching area moves. In contrast, in the exemplary embodiment, since it is possible to use the size of the template image as the size of the matching area, a calculation for determining the size of the matching area is not required. Therefore, it is possible to realize a high-speed matching process.

Then, the image processing unit 33 determines whether the calculated matching score is greater than a predetermined threshold or not (step S106). If the matching score is greater than the predetermined threshold (step S106, yes), the image processing unit 33 determines whether the entire image has been retrieved or not (step S107). That is, the image processing unit 33 determines whether or not the matching process has been performed for the entire area of the image.

If the entire image has been retrieved (step S107, yes), the image recognition devise 30 terminates operation. If the entire image has not been retrieved (step S107, no), the image processing unit 33 determined a new target pixel (step S102). That is, the image processing unit 33 performs loop processing of steps S102 to S107 until the entire image has been retrieved.

On the other hand, if the matching score is equal to or less than a predetermined threshold (step S106, no), the image processing unit 33 determines whether or not the matching is performed using all of the extracted template images against the matching area (step S108).

If the matching is performed using all of the template images (step S108, yes), the image processing unit 33 determines whether all of the images have been retrieved or not (step S107). If entire image has been retrieved (step S107, yes), the image recognition devise 30 terminates operation. If entire image has not been retrieved (step S107, no), the image processing unit 33 determined a new target pixel (step S102).

On the other hand, if the matching is not performed using all of the template images (step S108, no), the image processing unit 33 performs the matching using the template image for which the matching has not been performed yet from among the extracted template images (step S105). That is, the image processing unit 33 performs loop processing of steps S105 and S106 until the matching score is greater than the predetermined threshold (step S106, yes) or the matching for all of the extracted template images has been finished(step S108, yes).

As described above, according to the configuration of the image recognition devise 30 according to the present embodiment, the image processing unit 33 acquires the camera image taken by using the camera 10 and the 3D image taken by using the 3D sensor 20. The image extracting unit 32 acquires the subject distance information of the target pixel from the 3D image. The image extracting unit 32 extracts the template image groups corresponding to the acquired subject distance information from the plurality of the template image groups stored in the object DB 34 in advance. The image processing unit 33 performs the template matching against the camera image and the 3D image using the extracted template image groups. That is, the image processing unit 33 performs the template matching only using the template images extracted on the basis of the subject distance information from among the template images stored in the object DB 34. Therefore, it is not necessary to perform the matching process for all of the template images stored in the object DB34. As a result, the calculation amount of the matching process is reduced, and it is possible to reduce the processing time.

Further, since the feature amount of the image is not reduced in the matching process, it is possible to prevent deterioration of the accuracy of the matching process.

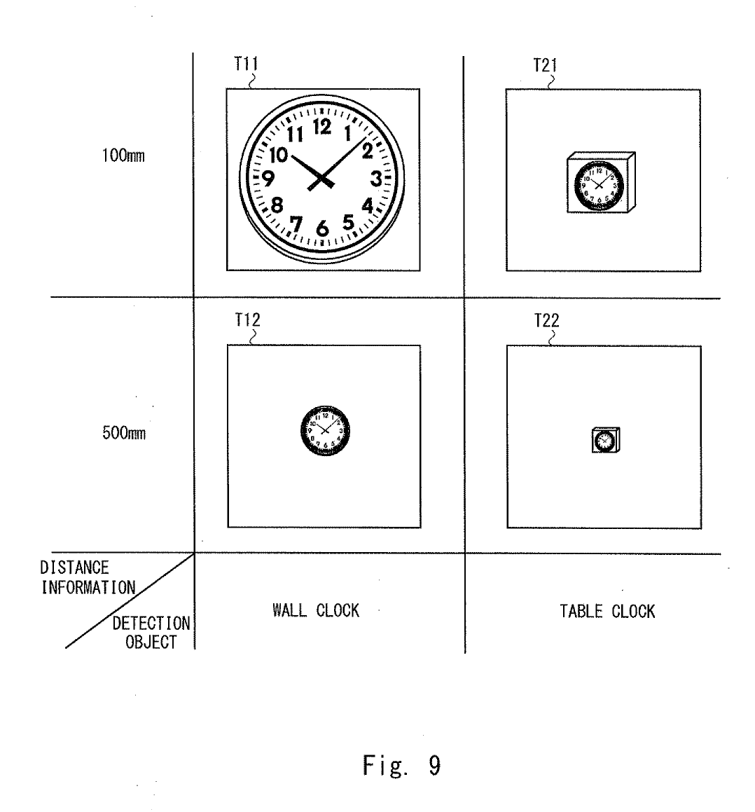

Further, according to the configuration of the present embodiment, detection errors in the matching process can be prevented. With reference to FIG. 9, the effect of preventing the detection errors will be described. FIG. 9 is an example of template images and the distance information stored in the object DB 34. Template images T11 and T12 are template images for a wall clock detected as being the detection object. The template image T11 is associated with the distance information of 100 mm, and the template image T12 is associated with the distance information of 500 mm. On the other hand, template images T21 and T22 are template images for a table clock detected as being the detection object. The template image T21 is associated with the distance information of 100 mm, and the template image T22 is associated with the distance information of 500 mm. For the purpose of illustration, it is assumed that the sizes of all the template images are the same. Further, for example, the diameter of the wall clock is 40 cm, and the diameter of the table clock is 5 cm, and thus the overall sizes of the detection objects are different.

Regardless of the subject distance of the target pixel, it is assumed that all of the template images T11, T12, T21, and T22 are used against one matching area. In this case, in the template images T12 and T21, the types of the detection objects are different, but the sizes (the number of pixels) and the shapes of the detection objects are similar. Therefore, for example, the wall clock in the camera image may be erroneously detected as being a table clock, or the table clock may be erroneously detected as being a wall clock.

In contrast, according to the configuration of the present invention, if the subject distance information acquired from the 3D image is assumed to be 120 mm, the image extracting unit 32 extracts template images T11 and T21 associated with the distance information of 100 mm. Then, the image processing unit 33 performs the matching process using template images T11 and T21. In template images T11 and T21, the number of pixels occupied by the wall clock is greatly different from the number of pixels occupied by the table clock. Therefore, erroneous detection of the wall clock in the camera image as being the table clock, or erroneous detection of the table clock as being the wall clock can be prevented. Further, if the subject distance information acquired from the 3D image is assumed to be 480 mm, for example, the image extracting unit 32 extracts template images T12 and T22 in which the sizes (the number of the pixels) of the clock in template images are different from each other. Therefore, it is possible to prevent erroneous detection in the same manner as described above.

In the embodiment described above, both the camera image and the 3D image are used in the template matching, but it is possible to perform the matching process using either one of the two images. However, the template matching using the camera image has different characteristics from that using the 3D image. The matching process using the camera image is suitable for the detection of an object having a characteristic pattern (color information). In contrast, the matching process using the 3D image is suitable for the detection of an object having a characteristic shape because the color information is not considered. Therefore, by performing the template matching using both the camera image and the 3D image, it is possible to exploit each of the above characteristics and thus improve the detection accuracy.

Further, in the object DB34, a plurality of template images (i.e., the template image group) is associated with one distance information for one detection object, but is not limited thereto. That is, one template image may be associated with one distance information.

### First Modified Embodiment

The first modified embodiment according to the present embodiment will now be described. In the above embodiment, the template image used for the template matching is an image data including information about brightness and color. In contrast, in the first modified embodiment, the template matching is performed by comparing the feature amount (e.g., an edge feature amount) of the image.

For example, the image processing unit 33 calculates the edge feature amount of the matching area and generates an edge feature amount image. Each pixel of the edge feature amount image includes information regarding a direction and strength of a line segment included in the pixel, not information regarding brightness and color or the like. Further, the image processing unit 33 generates the edge feature amount image from the acquired template image from the object DB 34. Then, the image processing unit 33 calculates the score (degree of matching) by comparing the edge feature amount of the matching area with that of the template image.

### Second Modified Embodiment

The second modified embodiment according to the present embodiment will now be described. In the embodiment described above, the area-based matching is used as the pattern matching method. In contrast, in the second modified embodiment, the feature-based matching will be used as the pattern matching method. The feature-based matching is a method which detects feature points such as corners from an image, defines a local descriptor and histograms (the feature amount) of brightness information and color information and the like of a local region of its surroundings, and performs matching between images based on the distance of the feature amount. That is, the feature-based matching compares features included in images, but do not compare images (pixels or areas).

For example, the object DB34 stores information about the template image as the feature amount instead of the template image. The feature amount is stored in the object DB 34 in association with the distance information in advance in the same manner as the template image. That is, the object DB 34 stores the feature amount of the image instead of the template image as the image pattern.

Then, the image processing unit 33 calculates the feature amount of the matching area in the camera image. The image processing unit 33 extracts the feature amount associated with the subject distance information of the target pixel from among the feature amounts stored in the object DB 34. The image processing unit 33 performs the matching process by comparing the calculated feature amount with the extracted feature amount.

### Third Modified Embodiment

The third modified embodiment according to the present embodiment will now be described. In the above embodiment, the image processing unit 33 acquires the subject distance information which the target pixel (one pixel) has when it acquires the subject distance information of the target pixel from the 3D image. In contrast, in the third modified embodiment, the image processing unit 33 calculates the average value of a plurality of pieces of the subject distance information which the pixel regarded as the target pixel have and the peripheral pixels of the target pixel have. Then, the image extracting unit 32 detects the distance information close to the calculated average value from a plurality of pieces of the subject distance information stored in the object DB 34 and extracts template image group associated with the detected distance information.

For example, as shown in FIG. 10, the image extracting unit 32 regards an average value of the pieces of the subject distance information which the pixel corresponding to the target pixel P1 and eight pixels adjacent to the target pixel P1 have as the subject distance information of the target pixel P1. In particular, although the subject distance information which the pixel corresponding to the target pixel has is 530 mm, the average value of all nine pieces of the subject distance information is 540 mm. Thus, the image extracting unit 32 detects the distance information close to the calculated average value of 540 mm from a plurality of pieces of the subject distance information stored in the object DB 34 and extracts a template image group associated with the detected distance information.

Thus, by using the average value of the pieces of the subject distance information of the target pixel and the peripheral pixels of the target pixel, it is possible to reduce the influence of noise of the target pixel. The pixels used in the average are not limited to pixels adjacent to the pixel corresponding to the target pixel, and it is possible to use pixels from a wider range. Further, a weighted average value weighted the subject distance information of the target pixel more than the subject distance information of the peripheral pixels instead of a simple average value of the nine pixels may be used.

### Fourth Modified Embodiment

The fourth modified embodiment according to the present embodiment will now described. In the above embodiment, as shown in FIG. 8, the image extracting unit 32 detects the distance information around the subject distance information of the target pixel from among the plurality of pieces of the distance information stored in the object DB 34. In contrast, in the fourth modified embodiment, the image extracting unit 32 detects the nearest distance information as the subject distance information of the target pixel. That is, the image extracting unit 32 detects the distance information having the smallest difference between itself and the acquired subject distance information from the object DB 34.

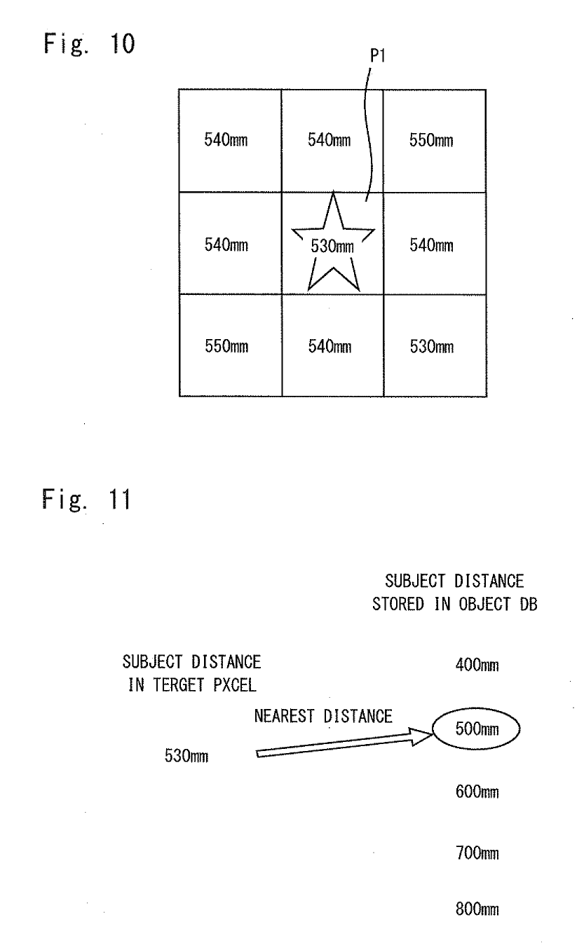

For example, in the example shown in FIG. 11, the subject distance information of the target pixel which is acquired by the image extracting unit 32 is 530 mm. Therefore, the image extracting unit 32 detects 500 mm which is the distance information nearest to 530 mm (having the shortest distance difference from 530 mm). Then, the image extracting unit 32 extracts only the template image group associated with the detected distance information of 500 mm. Therefore, the number of the template images for the matching process is reduced compared with the embodiment described above. As a result, the calculation amount of the matching process is reduced and thereby it is possible to reduce the process time.

### Fifth Modified Embodiment

The fifth modified embodiment according to the present embodiment will now be described. In the above embodiment, the image processing system including the image recognition device has been described, but the entire system may be applied to a robot.

For example, it is possible to apply the above image processing system to a robot which is required to detect the predetermined detection object in the surrounding environment. Specifically, the robot includes the camera, the 3D sensor, and the image recognition device. Note that the robot which moves in response to the surrounding environment typically has the camera and the 3D sensor to determine the condition of the surrounding environment, and these devices can be used.

The robot generates the camera image using the camera. Further, the robot generates the 3D image using the 3D sensor. Then, as described above, the image recognition device acquires the subject distance information of the target pixel in the 3D image, extracts the template image from the object DB and performs the template matching against the camera image and the 3D image using the acquired image.

In this case, the robot does not necessarily have to generate the 3D image. For example, the robot may detect the subject distance to the subject corresponding to the target pixel each time the pixel is moved by using a simple distance sensor or the like. Thus, it is possible to acquire the subject distance at the target pixel without generating the 3D image.

Note that the present invention is not limited to the above embodiments, and it is possible to modify or combine the present invention without departing from the spirit thereof. For example, the template image is not only an image acquired by capturing the image of the subject (the detection object) but may instead be a virtual object image (CAD model or a three dimensionally-constructed object). When the virtual object image is used as the template image, template image groups are generated in associating the virtual object image with distance information, assuming that the virtual object image was taken from the predetermined distance.

From the above description of the present invention, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An image recognition method, comprising:
acquiring a shooting image generated by capturing an image of an object using an image generating device;
acquiring subject distance information indicating a distance from the object to the image generating device at a target pixel in the shooting image;
extracting an image pattern corresponding to the acquired subject distance information from a plurality of image patterns which are created for detecting one detection object in advance and are associated with a plurality of different pieces of distance information, respectively, and
performing a pattern matching using the extracted image pattern against the shooting image.

2. The image recognition method according to claim 1, wherein the shooting image includes a 3D image in which each pixel has the subject distance information, and the image pattern includes the 3D image of the detection object, further comprising;
acquiring the subject distance information at the target pixel from the 3D image as the shooting image;
extracting the 3D image of the detection object corresponding to the acquired subject distance information; and
performing pattern matching using the extracted 3D image of the detection object against the 3D image as the shooting image.

3. The image recognition method according to claim 2, wherein the shooting image further includes a color image in which each pixel has color information and the image pattern further includes the color image of the detection object, further comprising;
performing the pattern matching using the 3D image and the color image of the detection object against the 3D image and the color image as the shooting image.

4. The image recognition method according to claim 1, wherein the image pattern includes the template image showing the detection object,
a size of the template image differs depending on the distance information associated with the template image, and
a size of a comparison area which is compared with the template image in the shooting image varies according to the size of the template image used in the pattern matching.

5. The image recognition method according to claim 1, further comprising;
acquiring the subject distance information which the target pixel has and the subject distance information which peripheral pixels of the target pixel have;
calculating an average value of the acquired a plurality of pieces of the subject distance information; and
extracting the image pattern corresponding to the calculated average value from the plurality of image patterns created in advance.

6. The image recognition method according to claim 1, further comprising;
extracting the image pattern associated with the distance information having the smallest difference between itself and the acquired subject distance information from the plurality of image patterns created in advance.

7. A robot comprising,
an image generating device;
a memory which stores a plurality of image patterns associated with the plurality of different pieces of distance information respectively; and
an image recognition device performing an image recognition method according to claim 1.
